(19) United States
(12) Patent Application Publication
(10) Pub. No.: US 2002/0175566 A1
(43) Pub. Date: Nov. 28, 2002

(54) Anti-theft ignition switch assembly

(76) Inventors: Sheldon J. Allen, Southfield, MI (US); Joseph E. Khoury, Stromberg (DE); Steven R. Hoskins, Walled Lake, MI (US)

Correspondence Address: BLANK ROME COMISKY & MCCAULEY, LLP, 900 17TH STREET, N.W., SUITE 1000, WASHINGTON, DC, 20006, US

(21) Appl. No.: 09/862,645

(22) Filed: May 23, 2001

(51) Int. Cl. B60R 25/04

(52) U.S. Cl. 307/10.3

(57) ABSTRACT

An ignition system that includes an ignition switch assembly for preventing the short-circuiting of the ignition system is provided. The ignition switch assembly includes a contact carrier assembly that is in electrical switching contact with an electrical component, such as a printed circuit board, of the ignition system. The printed circuit board contains substantially all electronics of the ignition system separate and apart from the ignition switch assembly. Upon removing the ignition switch assembly from the ignition switch system, a switching contact member of the printed circuit board is destroyed thereby effectively preventing the ignition system from being short-circuited or “hot wired.”

### BACKGROUND OF THE INVENTION

1. Field of the Invention

The present invention generally relates to ignition switch assemblies that provide electrical switching contact. More specifically, the present invention relates to ignition switch assemblies that provide electrical switching contact to printed circuit boards which contain substantially all of the electronics and connections thereof associated with a steering system of an automotive vehicle. Upon removal of the switch assembly from the vehicle, “hot wiring” or short-circuiting of the vehicle is effectively prevented.

2. Discussion of the Background

Automotive original equipment manufacturers utilize more and more electronics in automotive vehicle steering systems, assemblies and the like. These systems include, for example, 4-wheel steering, electric power assisted steering, EVO, automatic roll stability, ignition systems and other like systems and assemblies.

Typically, ignition systems include ignition switch assemblies that contain electronics and components thereof associated with the vehicle ignition system. However, these types of ignition systems allow easier access to the electronics of the vehicle ignition system. In this regard, the electronics, such as resistors, can be directly accessed within the ignition switch assembly of the vehicle ignition system. The switch assemblies generally can be opened and accessed with relative ease. Therefore, the electronics contained within the conventional switch assemblies can be utilized by, for example, a thief to short-circuit or “hot wire” the ignition system thereby allowing for the vehicle to be started.

A need, therefore exists, to provide an ignition system that makes it much more difficult and/or effectively prevents the ignition system to be “hot wired.”

### SUMMARY OF THE INVENTION

The present invention provides an ignition system that includes a removably attached ignition switch assembly for effectively preventing the ignition system from being “hot wired.” In this regard, the ignition switch assembly essentially contains no electronics, such as wires, resistors, connections and the like, associated with the ignition system. This prevents, for example, a thief to short-circuit the ignition system via the switch assembly.

To this end, in an embodiment of the present invention, an ignition switch assembly for an ignition switch system is provided. The ignition switch assembly includes a housing enclosing a contact carrier assembly and a base member wherein the contact carrier assembly insertably engages the base member for guiding the contact carrier assembly into electrical switching contact with the ignition system.

In another embodiment, an anti-theft ignition switch system is provided. The switch system can be utilized for a steering system of an automotive vehicle. The ignition switch system includes a printed circuit board having a switch contact member that is contained within the steering system. The printed circuit board contains substantially all of the electronics and connections thereof associated with the steering system of the automotive vehicle. The ignition switch system also includes an ignition switch assembly which is removably mounted to the steering system. The ignition switch assembly includes a housing that encloses a base member and a contact carrier assembly which insertably engages the base member for guiding the contact carrier assembly into electrical switching contact with the printed circuit board. When the ignition switch assembly is removed from the steering system, the switch contact member of the printed circuit board is destroyed.

In yet another embodiment, a method of preventing theft of an automotive vehicle is provided. The method includes the steps of providing a printed circuit board that has a switch contact member wherein the printed circuit board is contained within a steering system of an automotive vehicle; attaching an ignition switch assembly to the steering system wherein the ignition switch assembly includes a contact carrier assembly for providing electrical switching contact to the printed circuit board; and destroying the switch contact member of the printed circuit board when the ignition switch assembly is removed from the steering system.

It is, therefore, an advantage of the present invention to provide an ignition system that includes an ignition switch assembly for preventing short-circuiting of the ignition system.

Another advantage of the present invention is to utilize an ignition switch assembly that contains essentially no electronics associated with the ignition system.

A further advantage of the present invention is to provide a printed circuit board of the ignition system that contains substantially all of the electronics of the ignition system.

A still further advantage of the present invention is to provide an ignition switch assembly that can be manufactured at reduced cost and that can be readily incorporated into an ignition system of an automotive vehicle.

Yet another advantage of the present invention is to provide an ignition system that includes an ignition switch assembly which can be mounted to an automotive steering system for preventing “hot wiring” of the automotive vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an exploded view of the ignition switch assembly of the present invention; and

FIG. 2 illustrates the ignition system showing the ignition switch assembly in electrical switching contact with the printed circuit board of the present invention.

### DETAILED DESCRIPTION OF THE PRESENTLY PREFERRED EMBODIMENTS

The present invention provides an ignition system that includes an ignition switch assembly and an electronic component which is in electrical switching contact with the ignition switching assembly. The electronic component of the ignition system contains substantially all of the electronics, such as wires, resistors, connections and the like, of the ignition system. This prevents the ignition system from being short-circuited via the ignition switch assembly. Thus, the present invention can be utilized to prevent an automotive vehicle from being “hot wired” via an ignition system of the vehicle.

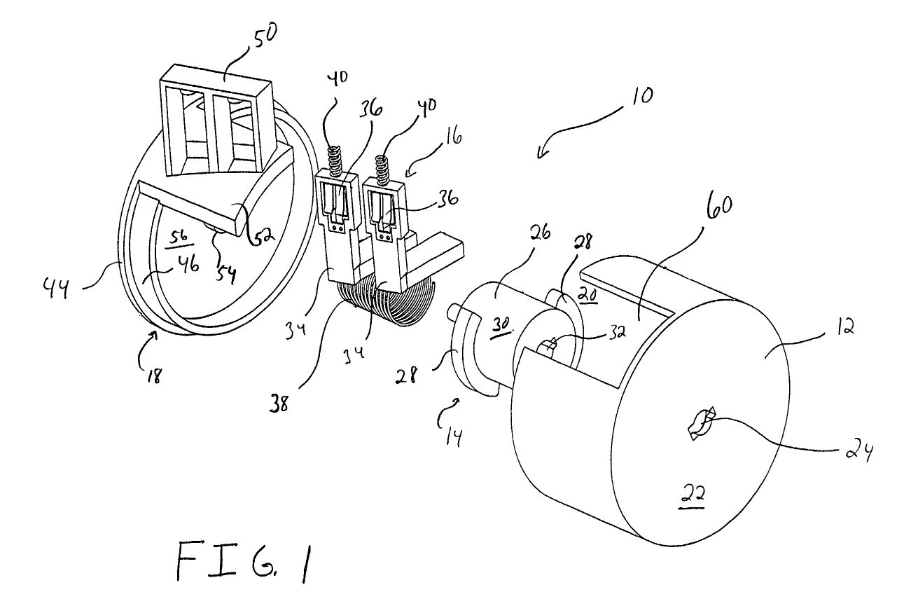

In an embodiment, the ignition switch assembly 10 of the present invention is illustrated in FIG. 1. The ignition switch assembly 10 includes a housing 12 that encloses an actuator cam 14 which engages a contact carrier assembly 16. The actuator cam 14 and contact carrier assembly 16 are insertably placed within a base member 18 of the ignition switch assembly 10. The housing 12 can include a variety of different shapes and sizes and can be made up of a variety of different materials. Preferably, the housing 12 is cylindrically shaped and has an open end 20 for receiving and enclosing the components of the ignition switch assembly 10 as illustrated in FIG. 1. The housing 12 includes a closed end 22 having an opening 24 through which a key can be inserted into the ignition system. The housing is preferably made of a molded plastic material.

The actuator cam 14 can include a variety of shapes and sizes and can be made from a variety of different materials. In a preferred embodiment, the actuator cam 14 includes a cylindrically shaped member 26 that has appendages 28 extending from a surface 30 of the cylindrically shaped member 26. The actuator cam 14 includes an opening 32 through which the key can be inserted into the ignition system. In operation, the actuator cam 14 functions to translate the rotary motion of a lock and key assembly of the ignition system into linear motion via the appendages 28 directed to the contact carrier assembly 16. The actuator cam 14 is preferably made of a molded plastic material.

The contact carrier assembly 16 can include a variety of different components and configurations which can be made from a variety of different materials. In a preferred embodiment, the contact carrier assembly 16 includes a pair of contact carrier members 34 as illustrated in FIG. 1. The contact carriers 34 form an L-shaped structure which includes contact leafs 36 molded within the structure. The contact carrier member 34 is preferably made of a molded plastic material. The contact leafs 36 are preferably made from a conductive material, such as a metal based material.

In an embodiment, the ignition switch assembly 10 includes a cam return member 38 and a reset member 40 as further illustrated in FIG. 1. The cam return member 38 provides rotary force to the actuator cam 14 in order to reset the entire ignition system. The cam return member 38 is preferably a spring made from metal. It should be appreciated that the cam return member 38 can include a variety of shapes, sizes and other like materials.

The reset member 40 is utilized to provide a contact force directed to the contact carrier assembly 16. This ensures that the contact carrier members 34 engage the actuator cam 14. The reset member 40 preferably includes a pair of springs made from metal. The reset springs compress against the contact carrier members 34 upon insertion within the base member 18. It should be appreciated that the reset member 40 can include a variety of shapes, sizes and other like material.

The base member 18 can include a variety of different shapes and sizes and can be made from a variety of different materials. Preferably, the base member 18 includes a circular shaped base element 44 as illustrated in FIG. 1. The base element 44 includes a flange-like member 46 that extends from a surface of the base element 44 for accepting and engaging the housing. The base element 44 preferably includes a two-chambered cavity 50 that extends from a platform member 52 which extends from the surface of the base element 44. A contact carrier member 34, along with a reset spring 40, can be inserted into each of the chambers of the cavity 50.

The base member 18 further includes a cavity or pocket 54 for receiving the cam return member 38. The cavity 54 extends from the platform member 52 into an opening 56 of the base member 18. The base member 18 is preferably made of a molded plastic material wherein each of the components of the base member 18, such as the base element 44, platform member 52, two-chambered cavity, etc., are integral parts of the base member. However, any number of the components of the base member can be discreet and separately attached components of the base member.

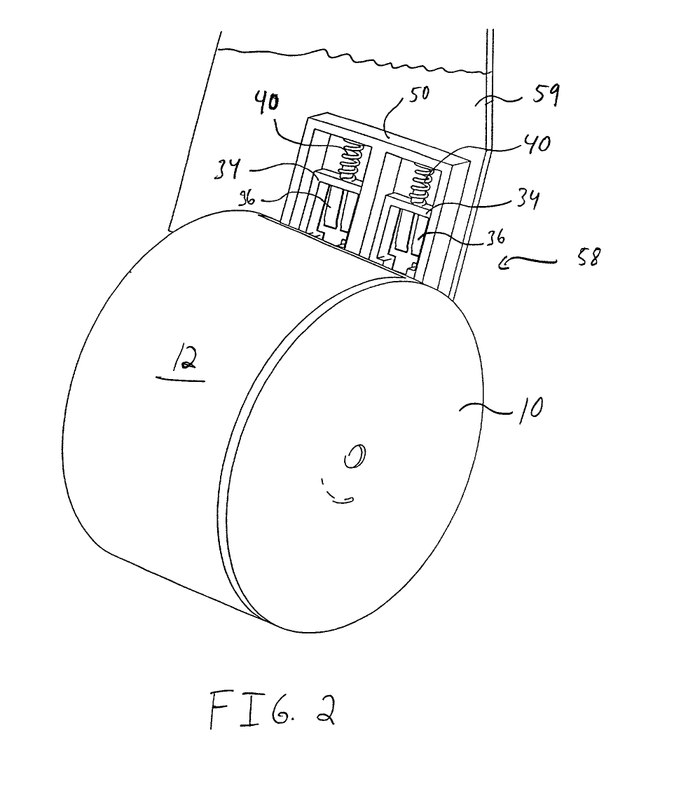

As assembled, the ignition switch assembly 10 effectively contains no electronics of the ignition system 58. The assembled ignition system assembly 10 can be mounted to the ignition system 58 in a variety of different ways. For example, the ignition switching assembly can be mounted or attached to a steering system 59 of an automotive vehicle. As illustrated in FIG. 2, the ignition switch assembly is preferably attached to a steering column of the steering system.

As shown in FIGS. 1 and 2, the contact carrier members 34 extend outwardly through an opening or slot 60 of the housing 12. As previously discussed, the contact carrier members 34 are contained within the two-chambered cavity 50 of the base member 18 of the ignition switch assembly 10. The two-chambered cavity 50 further acts to guide the contact carrier members 34 into electrical switching contact with the electronic components of the ignition system 58 which are contained within the steering column. This contact is made between the contact leafs 36 of the contact carrier members 34 and a respective switching contact member (not shown) associated with the electrical components of the ignition system 58. The electrical components preferably include a printed circuit board (not shown) that contains a variety of different electronics, such as multiple resistors and a multi-bit digital encoding system, preferably a three-bit digital encoding system.

As previously discussed, the printed circuit board contains substantially all of the electronics of the ignition system 58 that are necessary to start the vehicle. By removing the ignition switch assembly 10 to access the electronics of the printed circuit board, the switch contact members associated with the printed circuit board are destroyed. In this regard, the ignition system of the present invention effectively prevents short-circuiting or “hot wiring” of the ignition system in order to start the vehicle.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that all such changes and modifications be covered by the appended claims.

1. An ignition switch assembly for an ignition system comprising:
a contact carrier assembly;
a housing enclosing the contact carrier assembly; and
a base member, wherein the contact carrier assembly insertably engages the base member for guiding the contact carrier assembly into electrical switching contact with the ignition system.

2. The ignition switch assembly of claim 1 wherein the ignition system includes a printed circuit board having a switch contact member for providing electrical switching contact with the contact carrier assembly.

3. The ignition switch assembly of claim 2 wherein the switch contact member of the printed circuit board is destroyed when the ignition switch assembly is removed from the ignition system.

4. The ignition switch assembly of claim 3 wherein the switch contact member includes a plurality of resistors or contact pads.

5. The ignition switch assembly of claim 1 wherein the contact carrier assembly includes a pair of contact carriers each having contact leafs for providing electrical switching contact.

6. The ignition switch assembly of claim 1, further comprising an actuator cam that translates rotary motion into linear motion for contacting the contact carrier assembly to the ignition system.

7. The ignition switch assembly of claim 6 wherein the contact carrier assembly includes a reset member such that the contact carrier assembly engages the actuator cam.

8. The ignition switch assembly of claim 6, further comprising a cam return member for providing rotary force to the actuator cam to reset the ignition system

9. An anti-theft ignition switch system for a steering system of an automotive vehicle comprising:
a printed circuit board having a switch contact member contained within the steering system wherein the printer circuit board includes substantially all electronics and connections thereof associated with the steering system; and
an ignition switch assembly removably mounted to the steering system, the ignition switch assembly including a housing enclosing a base member and a contact carrier assembly insertably engaging the base member for guiding the contact carrier assembly into electrical switching contact with the printed circuit board wherein the switch contact member is destroyed when the ignition switch assembly is removed from the steering system.

10. The anti-theft ignition switch system of claim 9 wherein the printed circuit board includes a plurality of resistors or a multi-bit digital encoding system.

11. The anti-theft ignition switch system of claim 9 wherein the switch contact member includes a plurality of contact pads.

12. The anti-theft ignition switch system of claim 9 wherein the contact carrier assembly includes a pair of contact carriers each having contact leafs for providing electrical switching contact.

13. The anti-theft ignition switch system of claim 9, further comprising an actuator cam that translates rotary motion into linear motion for contacting the contact carrier assembly to the ignition system.

14. The anti-theft ignition switch system of claim 13 wherein the contact carrier assembly includes a reset member such that the contact carrier assembly engages the actuator cam.

15. The anti-theft ignition switch system of claim 13, further comprising a cam return member for providing a rotary force to the actuator cam to reset the anti-theft ignition switch system.

16. The anti-theft ignition switch system of claim 15 wherein the base member includes a cavity for housing the cam return member.

17. A method of preventing theft of an automotive vehicle comprising the steps of:
providing a printed circuit board having a switch contact member wherein the printed circuit board is contained within a steering system of the automotive vehicle;
attaching an ignition switch assembly to the steering system, the ignition switch assembly including a contact carrier assembly for providing electrical switching contact to the printed circuit board; and
destroying the switch contact member of the printed circuit board when the ignition switch assembly is removed from the steering system.

18. The method of claim 17 wherein the ignition switch assembly is attached to a steering column of the steering system.

19. The method of claim 17 wherein the ignition switch assembly includes a pair of contact carriers each having contact leafs for providing electrical switching contact.

20. The method of claim 17 wherein the printed circuit board includes substantially all electronics associated with the steering system.
